(19) United States
(12) Patent Application Publication
(10) Pub. No.: US 2026/0244002 A1
(43) Pub. Date: Aug. 20, 2026

(54) WIDE-ANGLE LENS ASSEMBLY

(71) Applicant: Asia Optical Co., Inc., Taichung (TW)

(72) Inventor: Yuan-Fan Liang, Taichung (TW)

(21) Appl. No.: 19/454,507

(22) Filed: Jan. 21, 2026

(30) Foreign Application Priority Data
Feb. 17, 2025 (TW) 114105744

(51) Int. Cl. G02B 13/06; G02B 9/64

(52) U.S. Cl. CPC G02B 13/06; G02B 9/64

(57) ABSTRACT

A wide-angle lens assembly includes a first lens, a second lens, a third lens, a fourth lens, a fifth lens, a sixth lens, a seventh lens, and an eighth lens, all of which are arranged in order from an object side to an image side along an optical axis. The first lens is with refractive power and includes a concave surface facing the image side. The second lens is a meniscus lens with refractive power. The third lens is with refractive power. The fourth lens is with positive refractive power and includes a convex surface facing the image side. The fifth lens is with positive refractive power and includes a convex surface facing the object side. The sixth lens is with negative refractive power. The seventh lens is a meniscus lens with refractive power. The eighth lens is with refractive.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have miniaturization and high resolution in accordance with different application requirements. However, the known wide-angle lens assembly can't satisfy such requirements. Therefore, the wide-angle lens assembly needs a new structure in order to meet the requirements of large field of view, miniaturization, and high resolution at the same time.

### BRIEF SUMMARY OF THE INVENTION

The invention provides a wide-angle lens assembly to solve the above problems. The wide-angle lens assembly of the invention is provided with characteristics of an increased field of view, a decreased total lens length, an increased resolution, and still has a good optical performance.

The wide-angle lens assembly in accordance with an exemplary embodiment of the invention includes a first lens, a second lens, a third lens, a fourth lens, a fifth lens, a sixth lens, a seventh lens, and an eighth lens. The first lens is with refractive power and includes a concave surface facing an image side. The second lens is a meniscus lens with refractive power. The third lens is with refractive power. The fourth lens is with positive refractive power and includes a convex surface facing the image side. The fifth lens is with positive refractive power and includes a convex surface facing an object side. The sixth lens is with negative refractive power. The seventh lens is a meniscus lens with refractive power. The eighth lens is with refractive. The first lens, the second lens, the third lens, the fourth lens, the fifth lens, the sixth lens, the seventh lens, and the eighth lens are arranged in order from the object side to the image side along an optical axis. A wide-angle lens assembly of the present invention can achieve the basic function when the wide-angle lens assembly satisfies the above features and does not require other additional features or conditions.

In another exemplary embodiment, the first lens is with negative refractive power; the second lens is with negative refractive power; the third lens is with positive refractive power; the seventh lens is with positive refractive power; and the eighth lens is with positive refractive power.

In yet another exemplary embodiment, the first lens further includes a convex surface facing the object side; the third lens is a biconvex lens and includes a convex surface facing the object side and another convex surface facing the image side; the fourth lens is a meniscus lens; the fifth lens is a biconvex lens and further includes another convex surface facing the image side; the sixth lens is a biconcave lens and includes a concave surface facing the object side and another concave surface facing the image side; the seventh lens includes a concave surface facing the object side and a convex surface facing the image side; and the eighth lens is a biconvex lens and includes a convex surface facing the object side and another convex surface facing the image side.

In another exemplary embodiment, the wide-angle lens assembly further includes a stop disposed between the fourth lens and the fifth lens.

In yet another exemplary embodiment, the second lens includes a concave surface facing the object side and a convex surface facing the image side.

In another exemplary embodiment, the second lens includes a convex surface facing the object side and a concave surface facing the image side.

In yet another exemplary embodiment, the fifth lens and the sixth lens are cemented or there is no air gap between the fifth lens and the sixth lens.

In another exemplary embodiment, the wide-angle lens assembly satisfies at least one of the following conditions: 2.69≤|f2/f|≤12.86; 0.82≤f4/f≤61.79; 1.96≤|fG1/f|≤6.14; 2.63≤(Nd5×Vd5)/(Nd6×Vd6)≤3.23; −0.28≤ (R21-R22)/(R21+R22)≤0.43; −2.66≤(R81-R82)/(R81+R82)≤1.56; −6.18≤ (R41+R42)/T4≤-4.49; 58.49≤TTL/d34≤93.31; 33.01≤TTL/d67≤49.03; 54.64 degree/mm≤FOV/f≤61.98 degree/mm; wherein f is an effective focal length of the wide-angle lens assembly, f2 is an effective focal length of the second lens, f4 is an effective focal length of the fourth lens, fG1 is a combined effective focal length of a combination of the first lens, the second lens, the third lens, and the fourth lens, Nd5 is a refractive index of the fifth lens, Vd5 is an Abbe number of the fifth lens, Nd6 is a refractive index of the sixth lens, Vd6 is an Abbe number of the sixth lens, R21 is a radius of curvature of an object side surface of the second lens, R22 is a radius of curvature of an image side surface of the second lens, R41 is a radius of curvature of an object side surface of the fourth lens, R42 is a radius of curvature of an image side surface of the fourth lens, R81 is a radius of curvature of an object side surface of the eighth lens, R82 is a radius of curvature of an image side surface of the eighth lens, T4 is an interval from the object side surface of the fourth lens to the image side surface of the fourth lens along the optical axis, TTL is an interval from an object side surface of the first lens to an image plane along the optical axis, d34 is an air interval from an image side surface of the third lens to the object side surface of the fourth lens along the optical axis, d67 is an interval from an image side surface of the sixth lens to an object side surface of the seventh lens along the optical axis, and FOV is a full field of view of the wide-angle lens assembly.

The wide-angle lens assembly in accordance with another exemplary embodiment of the invention includes a first lens, a second lens, a third lens, a fourth lens, a fifth lens, a sixth lens, a seventh lens, and an eighth lens. The first lens is with refractive power and includes a concave surface facing an image side. The second lens is with refractive power. The third lens is with refractive power. The fourth lens is a meniscus lens with positive refractive power and includes a concave surface facing an object side and a convex surface facing the image side. The fifth lens is with positive refractive power and includes a convex surface facing the object side. The sixth lens is with negative refractive power. The seventh lens is with refractive power. The eighth lens is with refractive. The first lens, the second lens, the third lens, the fourth lens, the fifth lens, the sixth lens, the seventh lens, and the eighth lens are arranged in order from the object side to the image side along an optical axis. A wide-angle lens assembly of the present invention can achieve the basic function when the wide-angle lens assembly satisfies the above features and does not require other additional features or conditions.

In another exemplary embodiment, the first lens is with negative refractive power; the second lens is with negative refractive power; the third lens is with positive refractive power; the seventh lens is with positive refractive power; and the eighth lens is with positive refractive power.

In yet another exemplary embodiment, the first lens further includes a convex surface facing the object side; the third lens is a biconvex lens and includes a convex surface facing the object side and another convex surface facing the image side; the fourth lens is a meniscus lens; the fifth lens is a biconvex lens and further includes another convex surface facing the image side; the sixth lens is a biconcave lens and includes a concave surface facing the object side and another concave surface facing the image side; the seventh lens includes a concave surface facing the object side and a convex surface facing the image side; and the eighth lens is a biconvex lens and includes a convex surface facing the object side and another convex surface facing the image side.

In another exemplary embodiment, the wide-angle lens assembly further includes a stop disposed between the fourth lens and the fifth lens.

In yet another exemplary embodiment, the second lens includes a concave surface facing the object side and a convex surface facing the image side.

In another exemplary embodiment, the second lens includes a convex surface facing the object side and a concave surface facing the image side.

In yet another exemplary embodiment, the fifth lens and the sixth lens are cemented or there is no air gap between the fifth lens and the sixth lens.

In another exemplary embodiment, the wide-angle lens assembly satisfies at least one of the following conditions: 2.69≤|f2/f|≤12.86; 0.82≤f4/f≤61.79; 1.96<|fG1/f|≤6.14; 2.63≤(Nd5×Vd5)/(Nd6×Vd6)≤3.23; −0.28<(R21-R22)/(R21+R22)≤0.43; −2.66≤(R81-R82)/(R81+R82)≤1.56; −6.18≤ (R41+R42)/T4≤-4.49; 58.49≤TTL/d34≤93.31; 33.01≤TTL/d67≤49.03; 54.64 degree/mm≤FOV/f≤61.98 degree/mm; wherein f is an effective focal length of the wide-angle lens assembly, f2 is an effective focal length of the second lens, f4 is an effective focal length of the fourth lens, fG1 is a combined effective focal length of a combination of the first lens, the second lens, the third lens, and the fourth lens, Nd5 is a refractive index of the fifth lens, Vd5 is an Abbe number of the fifth lens, Nd6 is a refractive index of the sixth lens, Vd6 is an Abbe number of the sixth lens, R21 is a radius of curvature of an object side surface of the second lens, R22 is a radius of curvature of an image side surface of the second lens, R41 is a radius of curvature of an object side surface of the fourth lens, R42 is a radius of curvature of an image side surface of the fourth lens, R81 is a radius of curvature of an object side surface of the eighth lens, R82 is a radius of curvature of an image side surface of the eighth lens, T4 is an interval from the object side surface of the fourth lens to the image side surface of the fourth lens along the optical axis, TTL is an interval from an object side surface of the first lens to an image plane along the optical axis, d34 is an air interval from an image side surface of the third lens to the object side surface of the fourth lens along the optical axis, d67 is an interval from an image side surface of the sixth lens to an object side surface of the seventh lens along the optical axis, and FOV is a full field of view of the wide-angle lens assembly.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1, 7, 13 are lens layout diagrams of a wide-angle lens assembly in accordance with a first, a second, and a third embodiments of the invention, respectively;

FIGS. 2, 3, 4, 5, 6 depict a longitudinal aberration diagram, a field curvature diagram, a distortion diagram, a lateral color diagram, and a modulation transfer function diagram of the wide-angle lens assembly in accordance with the first embodiment of the invention, respectively;

FIGS. 8, 9, 10, 11, 12 depict a longitudinal aberration diagram, a field curvature diagram, a distortion diagram, a lateral color diagram, and a modulation transfer function diagram of the wide-angle lens assembly in accordance with the second embodiment of the invention, respectively; and

FIGS. 14, 15, 16, 17, 18 depict a longitudinal aberration diagram, a field curvature diagram, a distortion diagram, a lateral color diagram, and a modulation transfer function diagram of the wide-angle lens assembly in accordance with the third embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, a sixth lens, a seventh lens, and an eighth lens. The first lens is with refractive power and includes a concave surface facing an image side. The second lens is a meniscus lens with refractive power. The third lens is with refractive power. The fourth lens is with positive refractive power and includes a convex surface facing the image side. The fifth lens is with positive refractive power and includes a convex surface facing an object side. The sixth lens is with negative refractive power. The seventh lens is a meniscus lens with refractive power. The eighth lens is with refractive power. The first lens, the second lens, the third lens, the fourth lens, the fifth lens, the sixth lens, the seventh lens, and the eighth lens are arranged in order from the object side to the image side along an optical axis. A lens assembly of the present invention is a preferred embodiment of the present invention when the lens assembly satisfies the above features.

The present invention provides another wide-angle lens assembly including a first lens, a second lens, a third lens, a fourth lens, a fifth lens, a sixth lens, a seventh lens, and an eighth lens. The first lens is with refractive power and includes a concave surface facing an image side. The second lens is with refractive power. The third lens is with refractive power. The fourth lens is a meniscus lens with positive refractive power and includes a concave surface facing an object side and a convex surface facing the image side. The fifth lens is with positive refractive power and includes a convex surface facing the object side. The sixth lens is with 185 negative refractive power. The seventh lens is with refractive power. The eighth lens is with refractive power. The first lens, the second lens, the third lens, the fourth lens, the fifth lens, the sixth lens, the seventh lens, and the eighth lens are arranged in order from the object side to the image side along an optical axis. A lens assembly of the present invention is a preferred embodiment of the present invention when the lens assembly satisfies the above features.

Referring to Table 1, Table 3, and Table 5, wherein Table 1, Table 3, and Table 5 show optical specification in accordance with a first, a second, and a third embodiments of the invention, respectively.

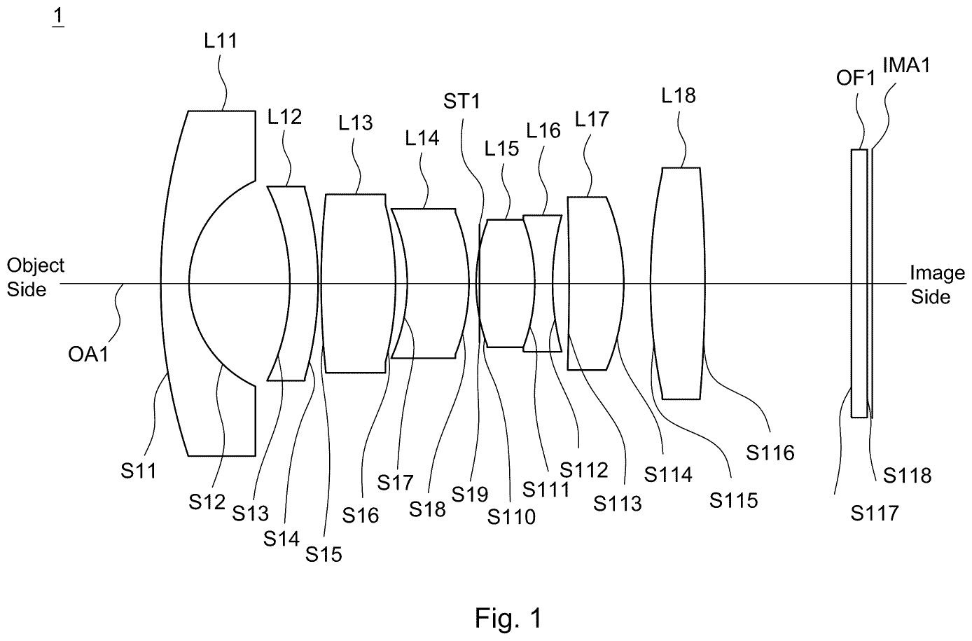

FIGS. 1, 7, and 13 are lens layout diagrams of the lens assemblies in accordance with the first, second, and third embodiments of the invention, respectively.

The first lenses L11, L21, L31 are meniscus lenses with negative refractive power, wherein the object side surfaces S11, S21, S31 are convex surfaces, the image side surfaces S12, S22, S32 are concave surfaces, and both of the object side surfaces S11, S21, S31 and image side surfaces S12, S22, S32 are spherical surfaces.

The second lenses L12, L22, L32 are with negative refractive power, wherein the object side surfaces S13, S23, S33 and image side surfaces S14, S24, S34 are spherical surfaces.

The third lenses L13, L23, L33 are biconvex lenses with positive refractive power, wherein the object side surfaces S15, S25, S35 are convex surfaces, the image side surfaces S16, S26, S36 are convex surfaces, and both of the object side surfaces S15, S25, S35 and image side surfaces S16, S26, S36 are spherical surfaces.

The fourth lenses L14, L24, L34 are meniscus lenses with positive refractive power, wherein the object side surfaces S17, S27, S37 are concave surfaces, the image side surfaces S18, S28, S38 are convex surfaces, and both of the object side surfaces S17, S27, S37 and image side surfaces S18, S28, S38 are spherical surfaces.

The fifth lenses L15, L25, L35 are biconvex lenses with positive refractive power, wherein the object side surfaces S110, S210, S310 are convex surfaces, the image side surfaces S111, S211, S311 are convex surfaces, and both of the object side surfaces S110, S210, S310 and image side surfaces S111, S211, S311 are spherical surfaces.

The sixth lenses L16, L26, L36 are biconcave lenses with negative refractive power, wherein the object side surfaces S111, S211, S311 are concave surfaces, the image side surfaces S112, S212, S312 are concave surfaces, and both of the object side surfaces S111, S211, S311 and image side surfaces S112, S212, S312 are spherical surfaces.

The fifth lenses L15, L25, L35 and the sixth lenses L16, L26, L36 are cemented and there is no air gap between the fifth lenses L15, L25, L35 and the sixth lenses L16, L26, L36, respectively.

The seventh lenses L17, L27, L37 are meniscus lenses with positive refractive power, wherein the object side surfaces S113, S213, S313 are concave surfaces, the image side surfaces S114, S214, S314 are convex surfaces, and both of the object side surfaces S113, S213, S313 and image side surfaces S114, S214, S314 are spherical surfaces.

The eighth lenses L18, L28, L38 are biconvex lenses with positive refractive power, wherein the object side surfaces S115, S215, S315 are convex surfaces, the image side surfaces S116, S216, S316 are convex surfaces, and both of the object side surfaces S115, S215, S315 and image side surfaces S116, S216, S316 are spherical surfaces.

In addition, the wide-angle lens assemblies 1, 2, and 3 satisfy at least one of the following conditions (1)-(10):

$$2.69 \leq \vert f 2 / f \vert \leq 12.86 ; \qquad ( 1 )$$

$$0.82 \leq f 4 / f \leq 61.79 ; \qquad ( 2 )$$

$$1.96 \leq \vert fG 1 / f \vert \leq 6.14 ; \qquad ( 3 )$$

$$2.63 \leq ( Nd 5 \times Vd 5 ) / ( Nd 6 \times Vd 6 ) \leq 3.23 ; \qquad ( 4 )$$

$$- 0.28 \leq ( R 21 - R 22 ) / ( R 21 + R 22 ) \leq 0.43 ; \qquad ( 5 )$$

$$- 2.66 \leq ( R 81 - R 82 ) / ( R 81 + R 82 ) \leq 1.56 ; \qquad ( 6 )$$

$$- 6.18 \leq ( R 41 + R 42 ) / T 4 \leq - 4.49 ; \qquad ( 7 )$$

$$58.49 \leq TTL / d 34 \leq 93.31 ; \qquad ( 8 )$$

$$33.01 \leq TTL / d 67 \leq 49.03 ; \qquad ( 9 )$$

$$54.64 degree / mm \leq FOV / f \leq 61.98 degree / mm ; \qquad ( 10 )$$

wherein the parameters in the first to third embodiments are defined as follows: f is an effective focal length of the wide-angle lens assemblies 1, 2, 3; f2 is an effective focal length of the second lenses L12, L22, L32; f4 is an effective focal length of the fourth lenses L14, L24, L34; fG1 is a combined effective focal length of a combination of the first lenses L11, L21, L31, the second lenses L12, L22, L32, the third lenses L13, L23, L33, and the fourth lenses L14, L24, L34; Nd5 is a refractive index of the fifth lenses L15, L25, L35; Vd5 is an Abbe number of the fifth lenses L15, L25, L35; Nd6 is a refractive index of the sixth lenses L16, L26, L36; Vd6 is an Abbe number of the sixth lenses L16, L26, L36; R21 is a radius of curvature of the object side surfaces S13, S23, S33 of the second lenses L12, L22, L32; R22 is a radius of curvature of the image side surfaces S14, S24, S34 of the second lenses L12, L22, L32; R41 is a radius of curvature of the object side surfaces S17, S27, S37 of the fourth lenses L14, L24, L34; R42 is a radius of curvature of the image side surfaces S18, S28, S38 of the fourth lenses L14, L24, L34; R81 is a radius of curvature of the object side surfaces S115, S215, S315 of the eighth lenses L18, L28, L38; R82 is a radius of curvature of the image side surfaces S116, S216, S316 of the eighth lenses L18, L28, L38; T4 is an interval from the object side surfaces S17, S27, S37 of the fourth lenses L14, L24, L34 to the image side surfaces S18, S28, S38 of the fourth lenses L14, L24, L34 along the optical axes OA1, OA2, OA3; TTL is an interval from the object side surfaces S11, S21, S31 of the first lenses L11, L21, L31 to the image planes IMA1, IMA2, IMA3 along the optical axes OA1, OA2, OA3; d34 is an air interval from the image side surfaces S16, S26, S36 of the third lenses L13, L23, L33 to the object side surfaces S17, S27, S37 of the fourth lenses L14, L24, L34 along the optical axes OA1, OA2, OA3; d67 is an air interval from the image side surfaces S112, S212, S312 of the sixth lenses L16, L26, L36 to the object side surfaces S113, S213, S313 of the seventh lenses L17, L27, L37 along the optical axes OA1, OA2, OA3; and FOV is a full field of view of the wide-angle lens assemblies 1, 2, 3. Making the wide-angle lens assemblies 1, 2, and 3 effectively shortening the total lens length, effectively increasing the resolution, and effectively correcting aberration.

A detailed description of a wide-angle lens assembly in accordance with a first embodiment of the invention is as follows. Referring to FIG. 1, the wide-angle lens assembly 1 includes a first lens L11, a second lens L12, a third lens L13, a fourth lens L14, a stop ST1, a fifth lens L15, a sixth lens L16, a seventh lens L17, an eighth lens L18, and an optical filter OF1, all of which are arranged in order from an object side to an image side along an optical axis OA1. In operation, the light from the object side is imaged on an image plane IMA1.

According to the foregoing, wherein: the object side surface S13 of the second lens L12 is a concave surface and the image side surface S14 is a convex surface; both of the object side surface S117 and image side surface S118 of the optical filter OF1 are plane surfaces; with the above design of the lenses, stop ST1, and at least one of the conditions (1)-(10) satisfied, the wide-angle lens assembly 1 can have an effective decreased total lens length, an effective increased resolution, and an effective corrected aberration. The wide-angle lens assembly of the present invention can meet the basic operation requirements when it only satisfies conditions (1), (2), (3), (4), (5), (6), (7), (8), (9), or (10), the refractive power of the fourth, fifth, sixth lenses are positive, positive, negative, respectively, the image side surface of the first lens is a concave surface, the second lens is a meniscus lens, the image side surface of the fourth lens is a convex surface, the object side surface of the fifth lens is a convex surface, the seventh lens is a meniscus lens; the wide-angle lens assembly of the present invention can meet the basic operation requirements when it only satisfies conditions (1), (2), (3), (4), (5), (6), (7), (8), (9), or (10), the refractive power of the fourth, fifth, sixth lenses are positive, positive, negative, respectively, the image side surface of the first lens is a concave surface, the object side surface of the fourth lens is a concave surface, the image side surface of the fourth lens is a convex surface, the object side surface of the fifth lens is a convex surface.

Table 1 shows the optical specification of the wide-angle lens assembly 1 in FIG. 1.

TABLE 1
Effective Focal Length = 2.67 mm F-number = 2.00
Total Lens Length = 18.03 mm Full Field of View = 164.70 degrees

| | | | | | Effective | |
|---|---|---|---|---|---|---|
| | Radius of | Thick- | | | Focal | |
| Surface | Curvature | ness | | | Length | |
| Number | (mm) | (mm) | Nd | Vd | (mm) | Remark |
| S11 | 14.58 | 0.70 | 1.90 | 37.37 | −4.09 | L11 |
| S12 | 2.88 | 2.57 | | | | |
| S13 | −5.43 | 0.70 | 1.59 | 61.14 | −26.13 | L12 |
| S14 | −8.78 | 0.09 | | | | |
| S15 | 25.95 | 1.87 | 2.10 | 17.02 | 5.52 | L13 |
| S16 | −7.76 | 0.30 | | | | |
| S17 | −4.56 | 1.56 | 1.80 | 42.25 | 86.69 | L14 |
| S18 | −4.93 | 0.27 | | | | |
| S19 | ∞ | −0.09 | | | | ST1 |
| S110 | 4.57 | 1.50 | 1.57 | 71.30 | 4.25 | L15 |
| S111 | −4.57 | 0.43 | 1.95 | 17.98 | −2.72 | L16 |
| S112 | 6.29 | 0.41 | | | | |
| S113 | −93.36 | 1.38 | 1.95 | 32.31 | 6.66 | L17 |
| S114 | −6.02 | 0.70 | | | | |
| S115 | 13.32 | 1.40 | 1.88 | 39.22 | 10.72 | L18 |
| S116 | −31.60 | 3.71 | | | | |
| S117 | ∞ | 0.40 | 1.52 | 64.17 | | |
| S118 | ∞ | 0.13 | | | | OF1 |

Table 2 shows the parameters and condition values for conditions (1)-(10) in accordance with the first embodiment of the invention. It can be seen from Table that the wide-angle lens assembly 1 of the first embodiment satisfies the conditions (1)-(10).

TABLE 2

| fG1 | 12.14 mm | T4 | 1.56 mm | d34 | 0.30 | mm |
|---|---|---|---|---|---|---|
| d67 | 0.41 mm | | | | | |
| \|f2/f\| | 9.78 | f4/f | 32.44 | \|fG1/f\| | 4.54 | |
| (Nd5 × Vd5)/(Nd6 × Vd6) | | 3.20 | (R21 − R22)/(R21 + R22) | | −0.24 | |
| (R81 − R82)/(R81 + R82) | | −2.46 | (R41 + R42)/T4 | | −6.10 | |
| TTL/d34 | 60.08 | TTL/d67 | 43.81 | FOV/f | 61.64 | degree/mm |

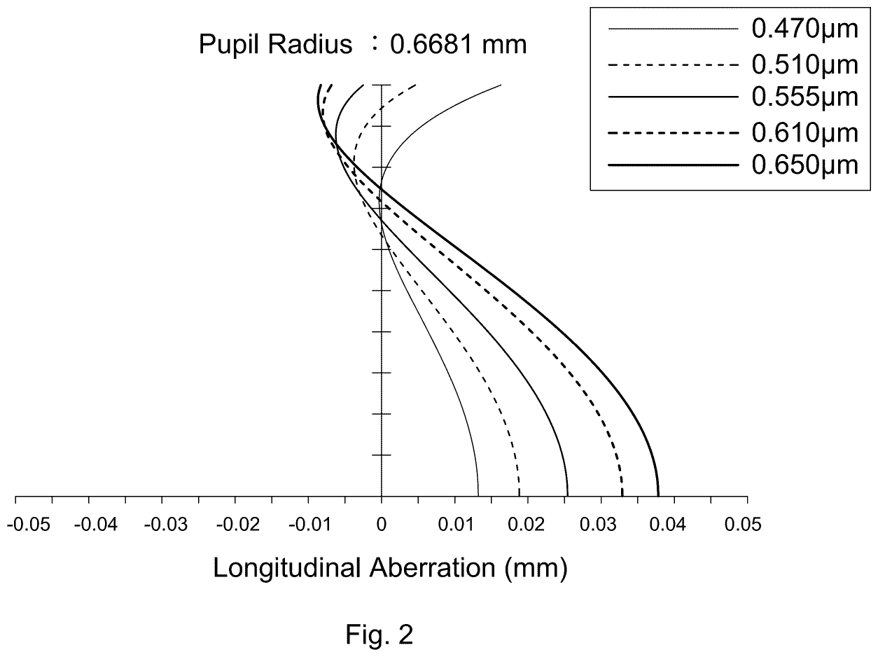

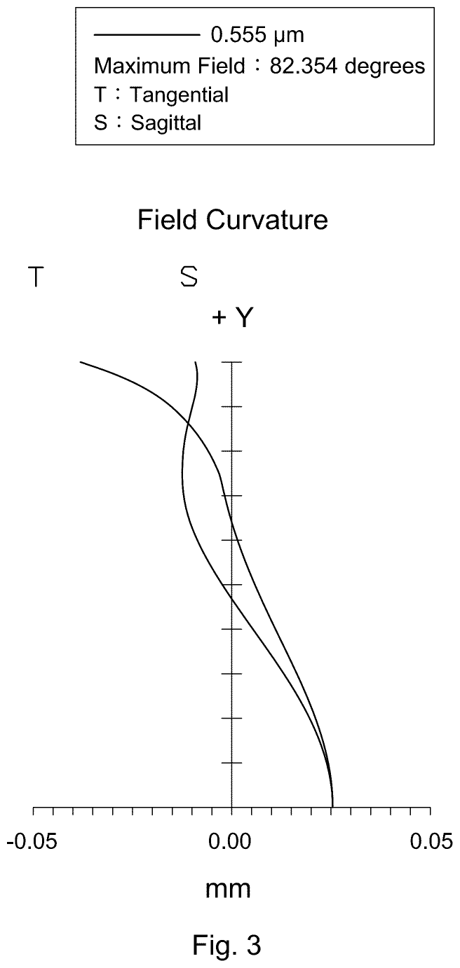

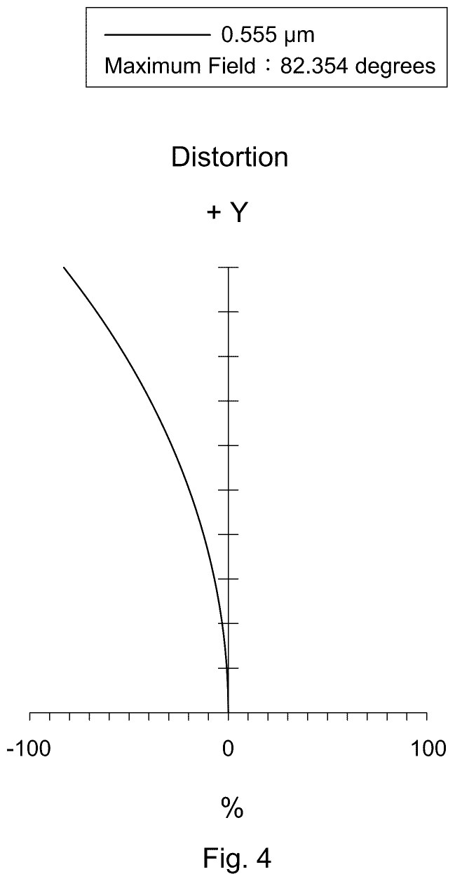

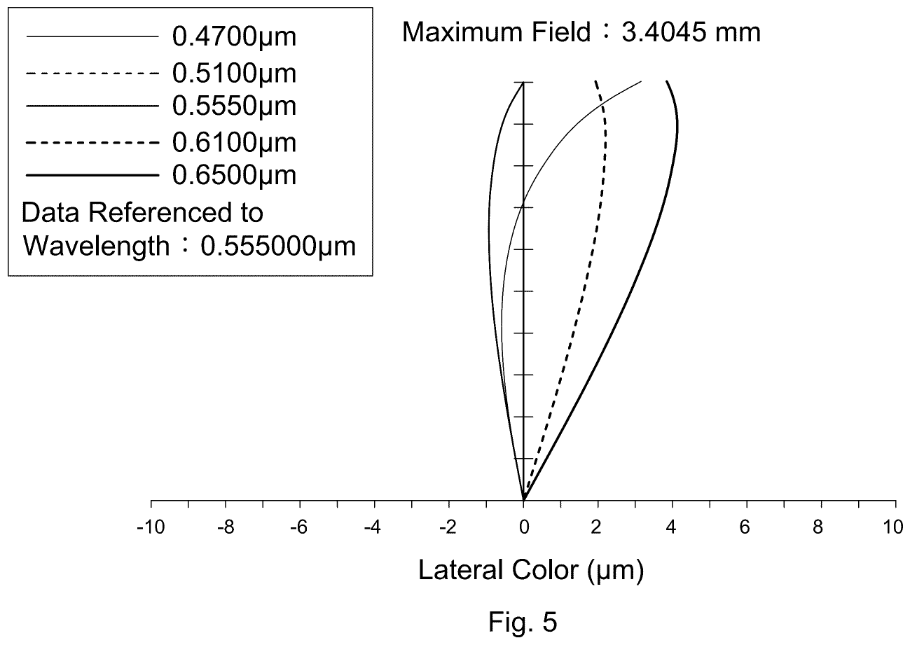

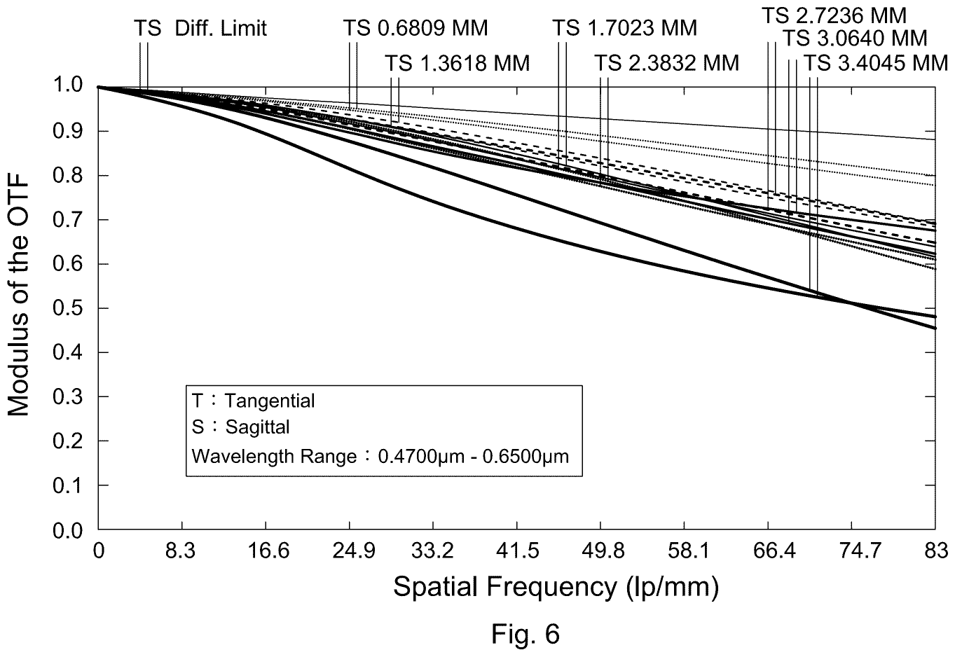

In addition, the wide-angle lens assembly 1 of the first embodiment can meet the requirements of optical performance as seen in FIGS. 2-6. It can be seen from FIG. 2 that the longitudinal aberration in the wide-angle lens assembly 1 of the first embodiment ranges from-0.01 mm to 0.04 mm. It can be seen from FIG. 3 that the field curvature of tangential direction and sagittal direction in the wide-angle lens assembly 1 of the first embodiment ranges from-0.04 mm to 0.03 mm. It can be seen from FIG. 4 that the distortion in the wide-angle lens assembly 1 of the first embodiment ranges from-90% to 0%. It can be seen from FIG. 5 that the lateral color in the wide-angle lens assembly 1 of the first embodiment ranges from-1.0 μm to 4.5 μm. It can be seen from FIG. 6 that the modulation transfer function in the wide-angle lens assembly 1 of the first embodiment ranges from 0.65 to 1.0. It is obvious that the longitudinal aberration, the field curvature, the distortion, and the lateral color can be corrected effectively and the resolution can also meet the requirements for the wide-angle lens assembly 1 of the first embodiment. Therefore, the wide-angle lens assembly 1 of the first embodiment is capable of good optical performance.

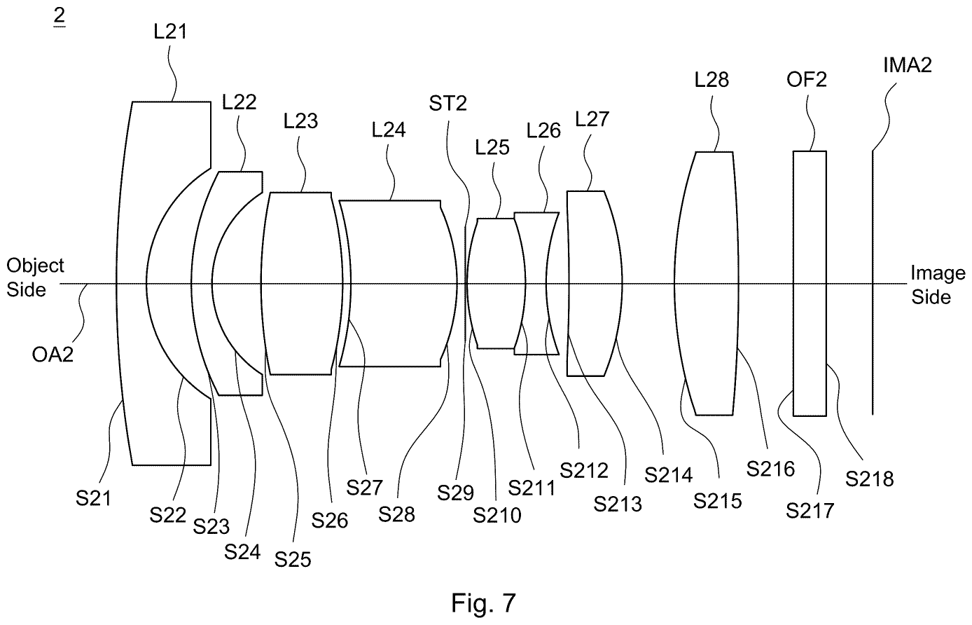

A detailed description of a wide-angle lens assembly in accordance with a second embodiment of the invention is as follows. Referring to FIG. 7, the wide-angle lens assembly 2 includes a first lens L21, a second lens L22, a third lens L23, a fourth lens L24, a stop ST2, a fifth lens L25, a sixth lens L26, a seventh lens L27, an eighth lens L28, and an optical filter OF2, all of which are arranged in order from an object side to an image side along an optical axis OA2. In operation, the light from the object side is imaged on an image plane IMA2.

According to the foregoing, wherein: the object side surface S23 of the second lens L22 is a convex surface and the image side surface S24 is a concave surface; both of the object side surface S217 and image side surface S218 of the optical filter OF2 are plane surfaces; with the above design of the lenses, stop ST2, and at least one of the conditions (1)-(10) satisfied, the wide-angle lens assembly 2 can have an effective decreased total lens length, an effective increased resolution, and an effective corrected aberration.

Table 3 shows the optical specification of the wide-angle lens assembly 2 in FIG. 7.

TABLE 3
Effective Focal Length = 2.64 mm F-number = 2.20
Total Lens Length = 18.33 mm Full Field of View = 149.80 degrees

| | | | | | Effective | |
|---|---|---|---|---|---|---|
| | Radius of | Thick- | | | Focal | |
| Surface | Curvature | ness | | | Length | |
| Number | (mm) | (mm) | Nd | Vd | (mm) | Remark |
| S21 | 25.65 | 0.70 | 1.77 | 49.46 | −4.89 | L21 |
| S22 | 3.27 | 1.12 | | | | |
| S23 | 5.91 | 0.50 | 1.59 | 68.26 | −8.36 | L22 |
| S24 | 2.62 | 1.21 | | | | |
| S25 | 11.95 | 1.96 | 1.85 | 25.15 | 5.90 | L23 |
| S26 | −8.19 | 0.20 | | | | |
| S27 | −7.34 | 2.58 | 1.83 | 42.72 | 9.52 | L24 |
| S28 | −4.44 | 0.20 | | | | |
| S29 | ∞ | 0.04 | | | | ST2 |
| S210 | 4.50 | 1.43 | 1.55 | 75.50 | 4.37 | L25 |
| S211 | −4.60 | 0.50 | 1.85 | 23.78 | −2.75 | L26 |
| S212 | 5.05 | 0.54 | | | | |
| S213 | −42.72 | 1.29 | 1.80 | 46.50 | 8.50 | L27 |
| S214 | −6.00 | 1.27 | | | | |
| S215 | 10.01 | 1.54 | 1.82 | 46.57 | 9.85 | L28 |
| S216 | −39.04 | 1.34 | | | | |
| S217 | ∞ | 0.80 | 1.52 | 64.17 | | |
| S218 | ∞ | 1.13 | | | | OF2 |

Table 4 Shows the Parameters and Condition Values for Conditions (1)-(10) in accordance with the second embodiment of the invention. It can be seen from Table 4 that the wide-angle lens assembly 2 of the second embodiment satisfies the conditions (1)-(10)

TABLE 4

| fG1 | 5.69 mm | T4 | 2.58 mm | d34 | 0.20 | mm |
|---|---|---|---|---|---|---|
| d67 | 0.54 mm | | | | | |
| \|f2/f\| | 3.16 | f4/f | 3.60 | \|fG1/f\| | 2.15 | |
| (Nd5 × Vd5)/(Nd6 × Vd6) | | 2.66 | (R21 − R22)/(R21 + R22) | | 0.39 | |
| (R81 − R82)/(R81 + R82) | | −1.69 | (R41 + R42)/T4 | | −4.57 | |
| TTL/d34 | 90.85 | TTL/d67 | 33.74 | FOV/f | 56.6 6 | degree/mm |

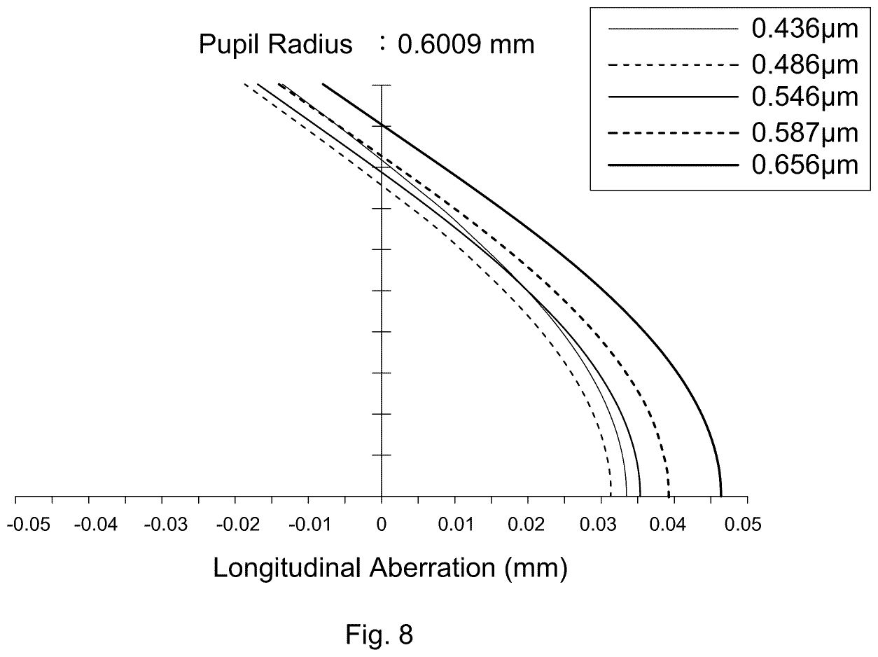

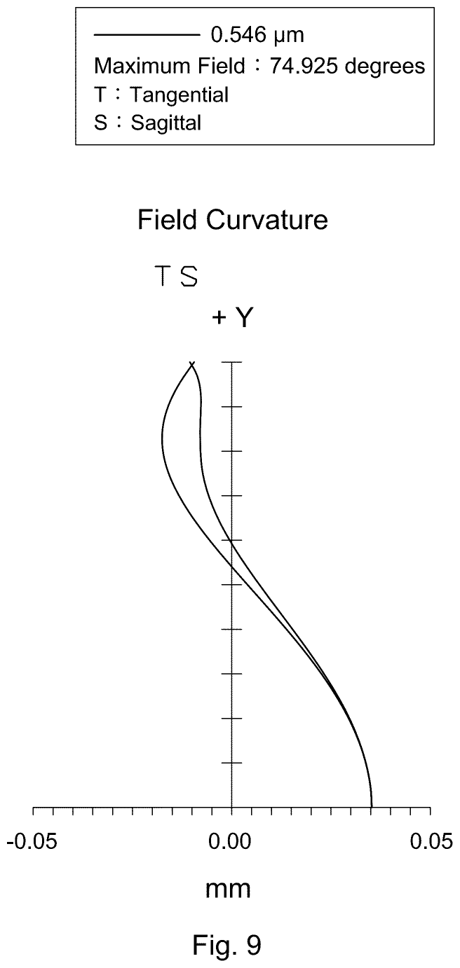

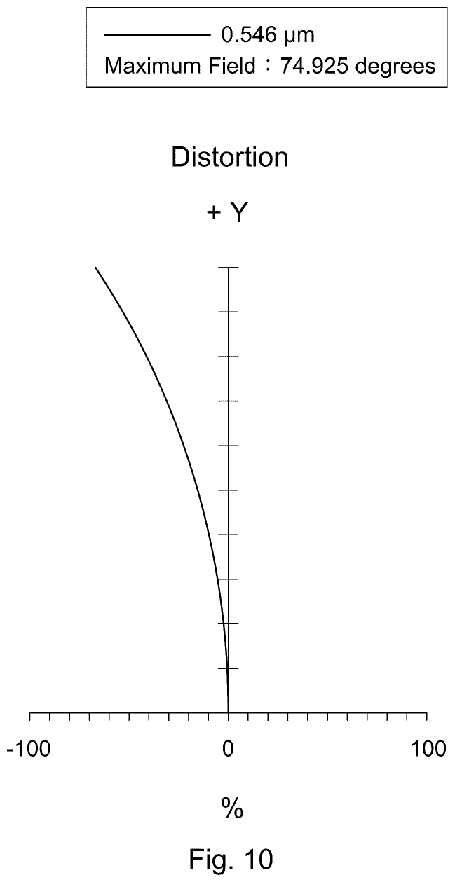

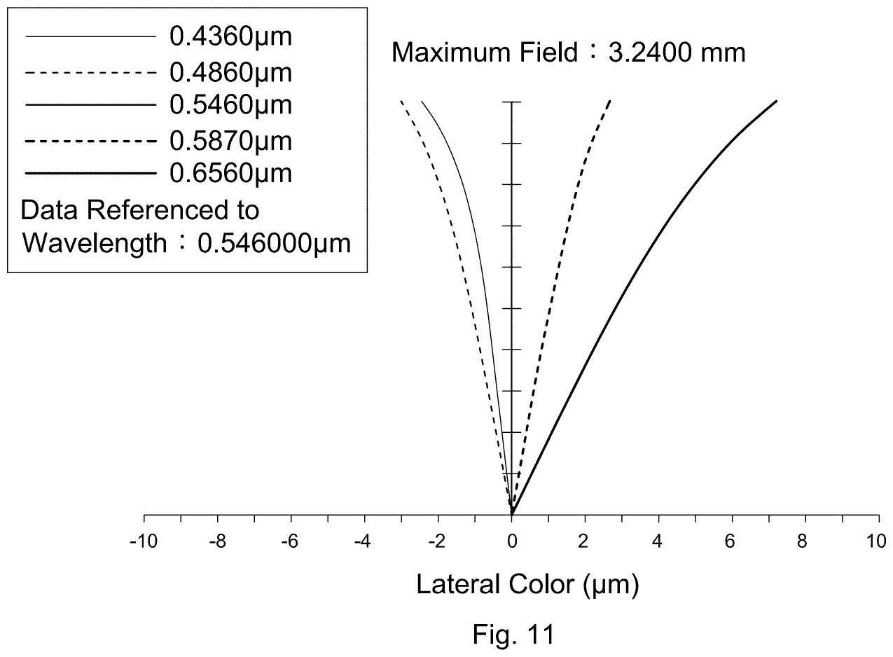

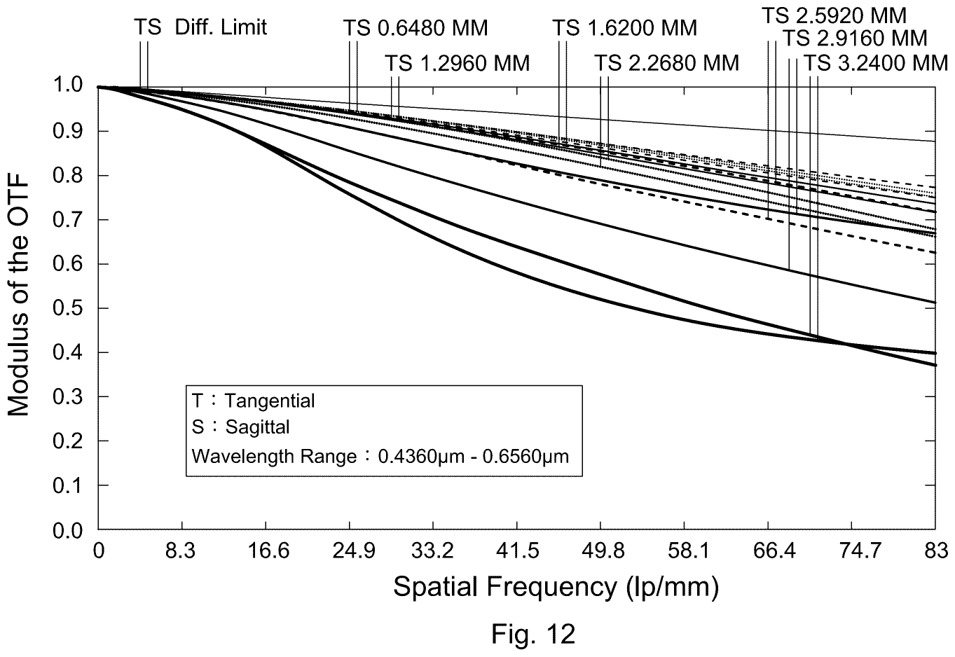

In addition, the wide-angle lens assembly 2 of the second embodiment can meet the requirements of optical performance as seen in FIGS. 8-12. It can be seen from FIG. 8 that the longitudinal aberration in the wide-angle lens assembly 2 of the second embodiment ranges from-0.02 mm to 0.05 mm. It can be seen from FIG. 9 that the field curvature of tangential direction and sagittal direction in the wide-angle lens assembly 2 of the second embodiment ranges from-0.02 mm to 0.04 mm. It can be seen from FIG. 10 that the distortion in the wide-angle lens assembly 2 of the second embodiment ranges from-70% to 0%. It can be seen from FIG. 11 that the lateral color in the wide-angle lens assembly 2 of the second embodiment ranges from −3.0 μm to 7.5 μm. It can be seen from FIG. 12 that the modulation transfer function in the wide-angle lens assembly 2 of the second embodiment ranges from 0.37 to 1.0. It is obvious that the longitudinal aberration, the field curvature, the distortion, and the lateral color can be corrected effectively and the resolution can also meet the requirements for the wide-angle lens assembly 2 of the second embodiment. Therefore, the wide-angle lens assembly 2 of the second embodiment is capable of good optical performance.

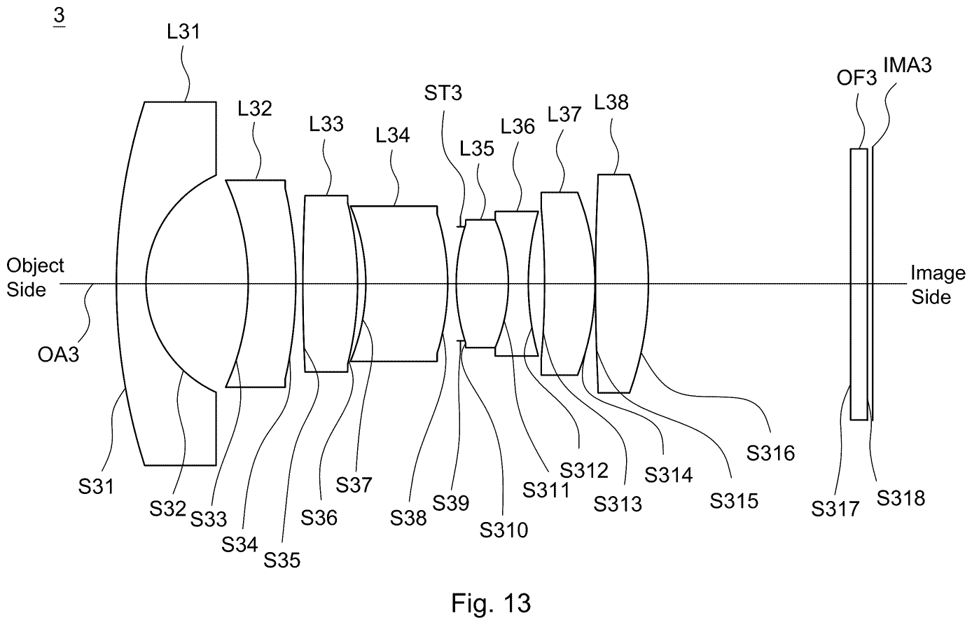

A detailed description of a wide-angle lens assembly in accordance with a third embodiment of the invention is as follows. Referring to FIG. 13, the wide-angle lens assembly 3 includes a first lens L31, a second lens L32, a third lens L33, a fourth lens L34, a stop ST3, a fifth lens L35, a sixth lens L36, a seventh lens L37, an eighth lens L38, and an optical filter OF3, all of which are arranged in order from an object side to an image side along an optical axis OA3. In operation, the light from the object side is imaged on an image plane IMA3.

According to the foregoing, wherein: the object side surface S33 of the second lens L32 is a concave surface and the image side surface S34 is a convex surface; both of the object side surface S317 and image side surface S318 of the optical filter OF3 are plane surfaces; with the above design of the lenses, stop ST3, and at least one of the conditions (1)-(10) satisfied, the wide-angle lens assembly 3 can have an effective decreased total lens length, an effective increased resolution, and an effective corrected aberration.

Table 5 shows the optical specification of the wide-angle lens assembly 3 in FIG. 13.

TABLE 5
Effective Focal Length = 2.69 mm F-number = 2.20
Total Lens Length = 18.01 mm Full Field of View = 147.90 degrees

| | | | | | Effective | |
|---|---|---|---|---|---|---|
| | Radius of | Thick- | | | Focal | |
| Surface | Curvature | ness | | | Length | |
| Number | (mm) | (mm) | Nd | Vd | (mm) | Remark |
| S31 | 14.39 | 0.70 | 1.77 | 49.62 | −4.69 | L31 |
| S32 | 2.84 | 2.43 | | | | |
| S33 | −6.00 | 1.14 | 1.49 | 70.24 | −33.33 | L32 |
| S34 | −10.10 | 0.17 | | | | |
| S35 | 50.00 | 1.30 | 2.10 | 17.02 | 6.22 | L33 |
| S36 | −7.94 | 0.20 | | | | |
| S37 | −4.87 | 1.95 | 1.90 | 37.37 | 158.75 | L34 |
| S38 | −5.61 | 0.30 | | | | |
| S39 | ∞ | −0.11 | | | | ST3 |
| S310 | 4.52 | 1.24 | 1.57 | 71.30 | 3.92 | L35 |
| S311 | −3.99 | 0.48 | 1.92 | 20.88 | −2.57 | L36 |
| S312 | 6.32 | 0.37 | | | | |
| S313 | −25.58 | 1.20 | 1.88 | 40.77 | 8.78 | L37 |
| S314 | −6.10 | 0.03 | | | | |
| S315 | 51.70 | 1.25 | 1.88 | 40.77 | 7.81 | L38 |
| S316 | −7.90 | 4.82 | | | | |
| S317 | ∞ | 0.40 | 1.52 | 64.17 | | |
| S318 | ∞ | 0.13 | | | | OF3 |

Table 6 shows the parameters and condition values for conditions (1)-(10) in accordance with the third embodiment of the invention. It can be seen from Table that the wide-angle lens assembly 3 of the third embodiment satisfies the conditions (1)-(10).

TABLE 6

| fG1 | 16.00 mm | T4 | 1.95 mm | d34 | 0.20 | mm |
|---|---|---|---|---|---|---|
| d67 | 0.37 mm | | | | | |
| \|f2/f\| | 12.39 | f4/f | 59.01 | \|fG1/f\| | 5.95 | |
| (Nd5 × Vd5)/(Nd6 × Vd6) | | 2.79 | (R21 − R22)/(R21 + R22) | | −0.25 | |
| (R81 − R82)/(R81 + R82) | | 1.36 | (R41 + R42)/T4 | | −5.37 | |
| TTL/d34 | 91.72 | TTL/d67 | 48.30 | FOV/f | 54.98 | degree/mm |

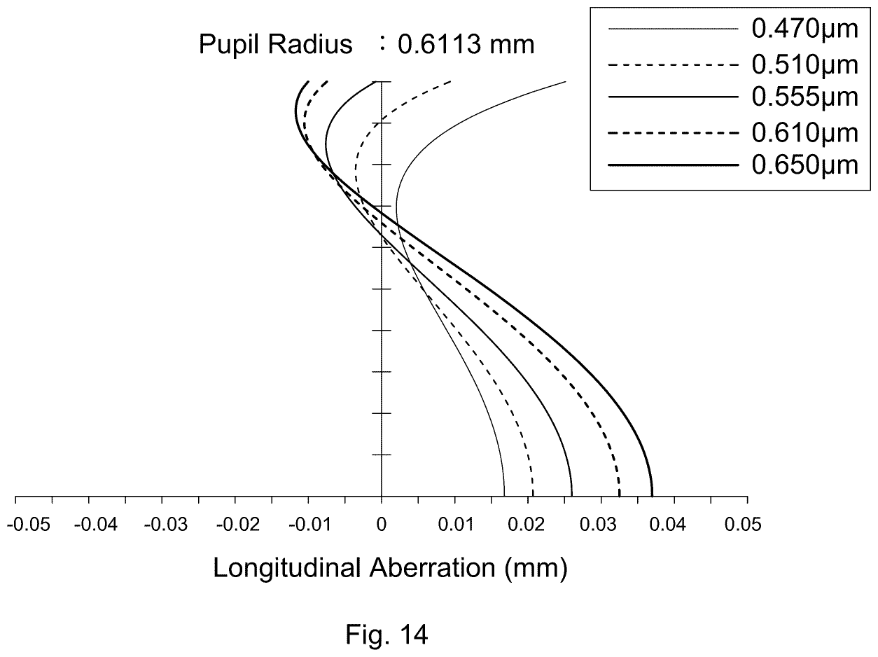

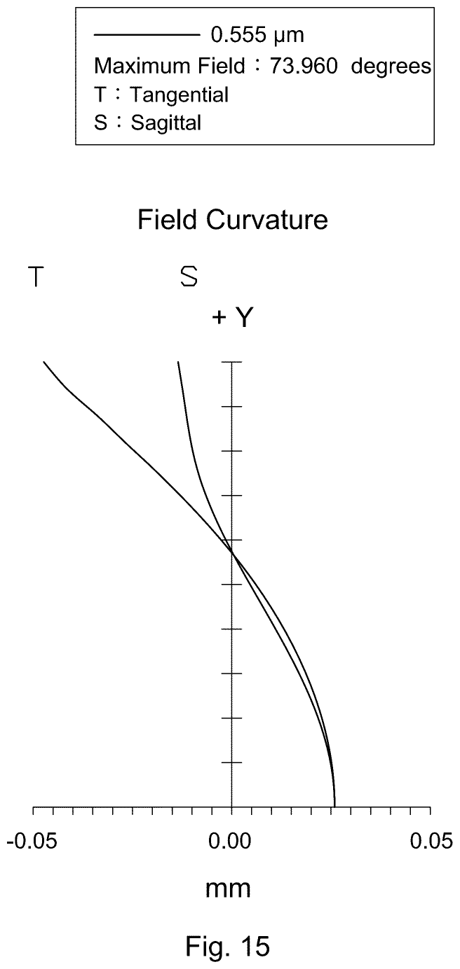

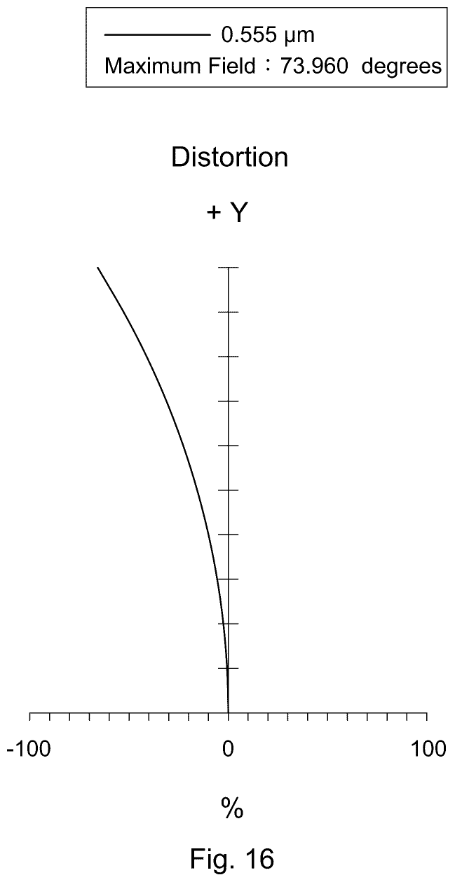

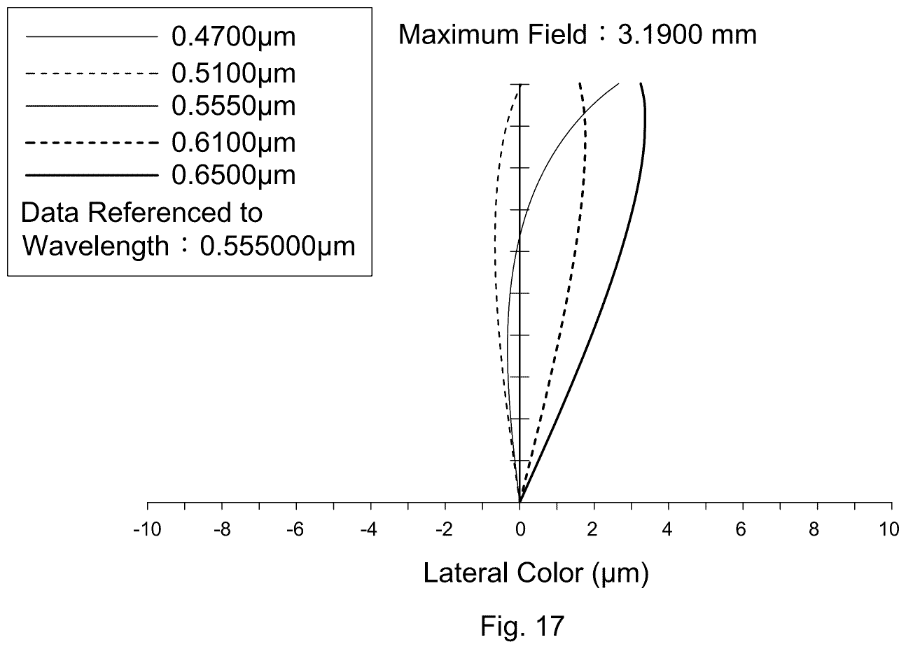

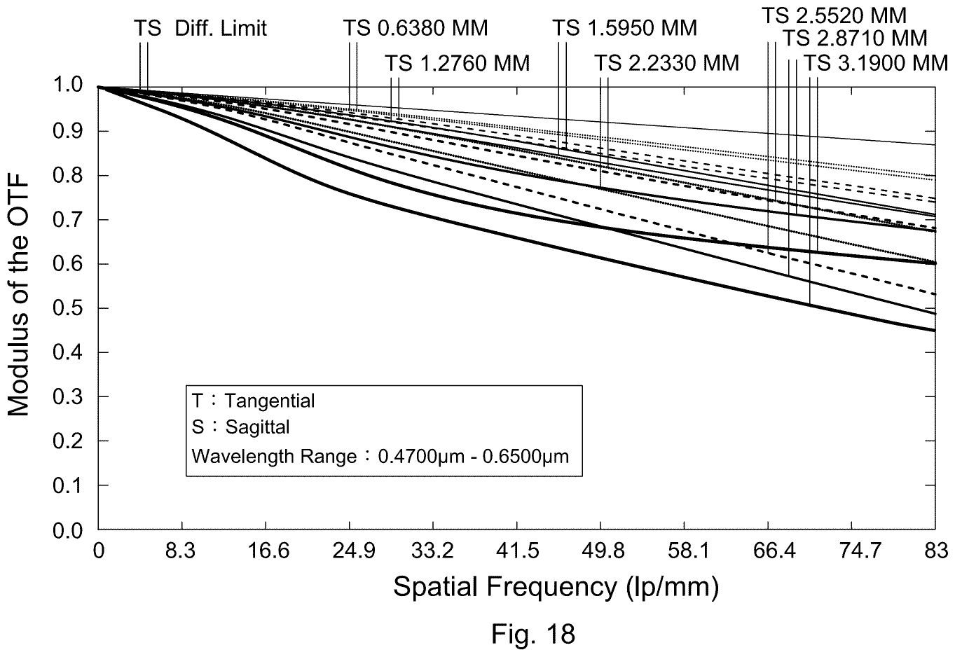

In addition, the wide-angle lens assembly 3 of the third embodiment can meet the requirements of optical performance as seen in FIGS. 14-18. It can be seen from FIG. 14 that the longitudinal aberration in the wide-angle lens assembly 3 of the third embodiment ranges from-0.015 mm to 0.04 mm. It can be seen from FIG. 15 that the field curvature of tangential direction and sagittal direction in the wide-angle lens assembly 3 of the third embodiment ranges from-0.05 mm to 0.03 mm. It can be seen from FIG. 16 that the distortion in the wide-angle lens assembly 3 of the third embodiment ranges from-70% to 0%. It can be seen from FIG. 17 that the lateral color in the wide-angle lens assembly 3 of the third embodiment ranges from-1.0 μm to 3.5 μm. It can be seen from FIG. 18 that the modulation transfer function in the wide-angle lens assembly 3 of the third embodiment ranges from 0.45 to 1.0. It is obvious that the longitudinal aberration, the field curvature, the distortion, and the lateral color can be corrected effectively and the resolution can also meet the requirements for the wide-angle lens assembly 3 of the third embodiment. Therefore, the wide-angle lens assembly 3 of the third embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens which is with refractive power and comprises a concave surface facing an image side;
a second lens which is a meniscus lens with refractive power;
a third lens which is with refractive power;
a fourth lens which is with positive refractive power and comprises a convex surface facing the image side;
a fifth lens which is with positive refractive power and comprises a convex surface facing an object side;
a sixth lens which is with negative refractive power;
a seventh lens which is a meniscus lens with refractive power; and
an eighth lens which is with refractive;
wherein the first lens, the second lens, the third lens, the fourth lens, the fifth lens, the sixth lens, the seventh lens, and the eighth lens are arranged in order from the object side to the image side along an optical axis.

2. The wide-angle lens assembly as claimed in claim 1, wherein:
the first lens is with negative refractive power;
the second lens is with negative refractive power;
the third lens is with positive refractive power;
the seventh lens is with positive refractive power; and
the eighth lens is with positive refractive power.

3. The wide-angle lens assembly as claimed in claim 2, wherein:
the first lens further comprises a convex surface facing the object side;
the third lens is a biconvex lens and comprises a convex surface facing the object side and another convex surface facing the image side;
the fourth lens is a meniscus lens;
the fifth lens is a biconvex lens and further comprises another convex surface facing the image side;
the sixth lens is a biconcave lens and comprises a concave surface facing the object side and another concave surface facing the image side;
the seventh lens comprises a concave surface facing the object side and a convex surface facing the image side; and
the eighth lens is a biconvex lens and comprises a convex surface facing the object side and another convex surface facing the image side.

4. The wide-angle lens assembly as claimed in claim 3, further comprising a stop disposed between the fourth lens and the fifth lens.

5. The wide-angle lens assembly as claimed in claim 3, wherein the second lens comprises a concave surface facing the object side and a convex surface facing the image side.

6. The wide-angle lens assembly as claimed in claim 3, wherein the second lens comprises a convex surface facing the object side and a concave surface facing the image side.

7. The wide-angle lens assembly as claimed in claim 3, wherein the fifth lens and the sixth lens are cemented or there is no air gap between the fifth lens and the sixth lens.

8. The wide-angle lens assembly as claimed in claim 1, wherein the wide-angle lens assembly satisfies at least one of following conditions:
$$2.69 \leq \vert f 2 / f \vert \leq 12.86 ;$$
$$0.82 \leq f 4 / f \leq 61.79 ;$$
$$1.96 \leq \vert fG 1 / f \vert \leq 6.14 ;$$
$$2.63 \leq ( Nd 5 \times Vd 5 ) / ( Nd 6 \times Vd 6 ) \leq 3.23 ;$$
$$- 0.28 \leq ( R 21 - R 22 ) / ( R 21 + R 22 ) \leq 0.43 ;$$
$$- 2.66 \leq ( R 81 - R 82 ) / ( R 81 + R 82 ) \leq 1.56 ;$$
$$- 6.18 \leq ( R 41 + R 42 ) / T 4 \leq - 4.49 ;$$
$$58.49 \leq TTL / d 34 \leq 93.31 ;$$
$$33.01 \leq TTL / d 67 \leq 49.03 ;$$
$$54.64 degree / mm \leq FOV / f \leq 61.98 degree / mm ;$$
wherein f is an effective focal length of the wide-angle lens assembly, f2 is an effective focal length of the second lens, f4 is an effective focal length of the fourth lens, fG1 is a combined effective focal length of a combination of the first lens, the second lens, the third lens, and the fourth lens, Nd5 is a refractive index of the fifth lens, Vd5 is an Abbe number of the fifth lens, Nd6 is a refractive index of the sixth lens, Vd6 is an Abbe number of the sixth lens, R21 is a radius of curvature of an object side surface of the second lens, R22 is a radius of curvature of an image side surface of the second lens, R41 is a radius of curvature of an object side surface of the fourth lens, R42 is a radius of curvature of an image side surface of the fourth lens, R81 is a radius of curvature of an object side surface of the eighth lens, R82 is a radius of curvature of an image side surface of the eighth lens, T4 is an interval from the object side surface of the fourth lens to the image side surface of the fourth lens along the optical axis, TTL is an interval from an object side surface of the first lens to an image plane along the optical axis, d34 is an air interval from an image side surface of the third lens to the object side surface of the fourth lens along the optical axis, d67 is an interval from an image side surface of the sixth lens to an object side surface of the seventh lens along the optical axis, and FOV is a full field of view of the wide-angle lens assembly.

9. A wide-angle lens assembly comprising:
a first lens which is with refractive power and comprises a concave surface facing an image side;
a second lens which is with refractive power;
a third lens which is with refractive power;
a fourth lens which is a meniscus lens with positive refractive power and comprises a concave surface facing an object side and a convex surface facing the image side;
a fifth lens which is with positive refractive power and comprises a convex surface facing the object side;
a sixth lens which is with negative refractive power;
a seventh lens which is with refractive power; and
an eighth lens which is with refractive;
wherein the first lens, the second lens, the third lens, the fourth lens, the fifth lens, the sixth lens, the seventh lens, and the eighth lens are arranged in order from the object side to the image side along an optical axis.

10. The wide-angle lens assembly as claimed in claim 9, wherein:
the first lens is with negative refractive power;
the second lens is with negative refractive power;
the third lens is with positive refractive power;
the seventh lens is with positive refractive power; and
the eighth lens is with positive refractive power.

11. The wide-angle lens assembly as claimed in claim 10, wherein:
the first lens further comprises a convex surface facing the object side;
the third lens is a biconvex lens and comprises a convex surface facing the object side and another convex surface facing the image side;
the fourth lens is a meniscus lens;
the fifth lens is a biconvex lens and further comprises another convex surface facing the image side;
the sixth lens is a biconcave lens and comprises a concave surface facing the object side and another concave surface facing the image side;
the seventh lens comprises a concave surface facing the object side and a convex surface facing the image side; and
the eighth lens is a biconvex lens and comprises a convex surface facing the object side and another convex surface facing the image side.

12. The wide-angle lens assembly as claimed in claim 11, further comprising a stop disposed between the fourth lens and the fifth lens.

13. The wide-angle lens assembly as claimed in claim 11, wherein the second lens comprises a concave surface facing the object side and a convex surface facing the image side.

14. The wide-angle lens assembly as claimed in claim 11, wherein the second lens comprises a convex surface facing the object side and a concave surface facing the image side.

15. The wide-angle lens assembly as claimed in claim 11, wherein the fifth lens and the sixth lens are cemented or there is no air gap between the fifth lens and the sixth lens.

16. The wide-angle lens assembly as claimed in claim 9, wherein the wide-angle lens assembly satisfies at least one of following conditions:
$$2.69 \leq \vert f 2 / f \vert \leq 12.86 ;$$
$$0.82 \leq f 4 / f \leq 61.79 ;$$
$$1.96 \leq \vert fG 1 / f \vert \leq 6.14 ;$$
$$2.63 \leq ( Nd 5 \times Vd 5 ) / ( Nd 6 \times Vd 6 ) \leq 3.23 ;$$
$$- 0.28 \leq ( R 21 - R 22 ) / ( R 21 + R 22 ) \leq 0.43 ;$$
$$- 2.66 \leq ( R 81 - R 82 ) / ( R 81 + R 82 ) \leq 1.56 ;$$
$$- 6.18 \leq ( R 41 + R 42 ) / T 4 \leq - 4.49 ;$$
$$58.49 \leq TTL / d 34 \leq 93.31 ;$$
$$33.01 \leq TTL / d 67 \leq 49.03 ;$$
$$54.64 degree / mm \leq FOV / f \leq 61.98 degree / mm ;$$
wherein f is an effective focal length of the wide-angle lens assembly, f2 is an effective focal length of the second lens, f4 is an effective focal length of the fourth lens, fG1 is a combined effective focal length of a combination of the first lens, the second lens, the third lens, and the fourth lens, Nd5 is a refractive index of the fifth lens, Vd5 is an Abbe number of the fifth lens, Nd6 is a refractive index of the sixth lens, Vd6 is an Abbe number of the sixth lens, R21 is a radius of curvature of an object side surface of the second lens, R22 is a radius of curvature of an image side surface of the second lens, R41 is a radius of curvature of an object side surface of the fourth lens, R42 is a radius of curvature of an image side surface of the fourth lens, R81 is a radius of curvature of an object side surface of the eighth lens, R82 is a radius of curvature of an image side surface of the eighth lens, T4 is an interval from the object side surface of the fourth lens to the image side surface of the fourth lens along the optical axis, TTL is an interval from an object side surface of the first lens to an image plane along the optical axis, d34 is an air interval from an image side surface of the third lens to the object side surface of the fourth lens along the optical axis, d67 is an interval from an image side surface of the sixth lens to an object side surface of the seventh lens along the optical axis, and FOV is a full field of view of the wide-angle lens assembly.
